(19) United States
(12) Patent Application Publication
(10) Pub. No.: US 2024/0418834 A1
(43) Pub. Date: Dec. 19, 2024

(54) DETECTION DEVICE, IN PARTICULAR OF A VEHICLE, FOR MONITORING AT LEAST ONE MONITORING REGION BY MEANS OF ELECTROMAGNETIC SCANNING SIGNALS, VEHICLE AND METHOD FOR OPERATING A DETECTION DEVICE

(71) Applicant: VALEO SCHALTER UND SENSOREN GMBH, Bietigheim-Bissingen (DE)

(72) Inventor: Thorsten Beuth, Bietigheim-Bissingen (DE)

(73) Assignee: VALEO SCHALTER UND SENSOREN GMBH, Bietigheim-Bissingen (DE)

(21) Appl. No.: 18/702,754

(22) PCT Filed: Oct. 13, 2022
(86) PCT No.: PCT/EP2022/078458

§ 371 Date: Apr. 18, 2024

(30) Foreign Application Priority Data
Oct. 19, 2021 (DE) 10 2021 127 000.6

(51) Int. Cl. G01S 7/481; G01S 17/42; G01S 17/931

(52) U.S. Cl. CPC G01S 7/4817; G01S 17/42; G01S 17/931

(57) ABSTRACT

A detection device of a vehicle for monitoring at least one monitoring region by means of electromagnetic scanning signals is disclosed. The detection device includes at least one emitting unit for emitting electromagnetic scanning signals into the at least one monitoring region. The detection device further includes at least one receiving unit for receiving electromagnetic echo signals which originate from scanning signals reflected int eh at least one monitoring region. The at least one emitting unit includes at least one signal source for generating electromagnetic scanning signals and at least one signal dispersion unit for dispersing electromagnetic scanning signals generated using the at least one signal source into at least one monitoring region surrounding an imaginary axis. The at least one signal dispersion unit includes at least one signal wave guide body for generating electromagnetic scanning signals.

### TECHNICAL FIELD

The invention relates to a detection device, in particular of a vehicle, for monitoring at least one monitoring region by means of electromagnetic scanning signals, comprising at least one emitting unit for emitting electromagnetic scanning signals into the at least one monitoring region, and comprising at least one receiving unit for receiving electromagnetic echo signals, which originate from scanning signals reflected in the at least one monitoring region, wherein the at least one emitting unit has at least one signal source for generating electromagnetic scanning signals and at least one signal dispersion unit for dispersing electromagnetic scanning signals generated using the at least one signal source in at least one monitoring region surrounding an imaginary axis.

Furthermore, the invention relates to a vehicle comprising at least one detection device for monitoring at least one monitoring region by means of electromagnetic scanning signals, wherein the at least one detection device has at least one emitting unit for emitting electromagnetic scanning signals into the at least one monitoring region, and at least one receiving unit for receiving electromagnetic echo signals, which originate from scanning signals reflected in the at least one monitoring region, wherein the at least one emitting unit has at least one signal source for generating electromagnetic scanning signals and at least one signal dispersion unit for dispersing electromagnetic scanning signals generated using the at least one signal source into at least one monitoring region surrounding an imaginary axis.

A method for operating a detection device, in particular of a vehicle, in which to monitor at least one monitoring region, electromagnetic scanning signals are generated using at least one signal source, dispersed using at least one signal dispersion unit, and are emitted into at least one monitoring region surrounding an imaginary axis, and echo signals, which originate from scanning signals reflected in the at least one monitoring region, are received.

### PRIOR ART

A 3D camera is known from DE 20 2014 101 550 U1. The 3D camera has, on the one hand, a camera unit having an image sensor and a control and evaluation unit and, on the other hand, an illumination unit having a light source. The camera unit and the illumination unit are assigned the mirror optical units designated in each case as panoramic mirrors or catadioptric optical units. The panoramic mirrors ensure that the field of view of the camera unit or the illumination field of the illumination unit is expanded to a large angle range of up to 360°.

The invention is based on the object of designing a detection device, a vehicle, and a method of the type mentioned at the outset, with which an expansion of at least one monitoring region can be implemented more easily. In particular, the expansion of the at least one monitoring region is to be implemented with lower expenditure, in particular space expenditure, component expenditure, installation expenditure, and/or method expenditure.

### DISCLOSURE OF THE INVENTION

This object is achieved according to the invention in the detection device in that the at least one signal dispersion unit comprises at least one signal wave guide body for guiding electromagnetic scanning signals, wherein the at least one signal wave guide body has at least one signal coupling region for a scanning signal coming from at least one signal source and at least one signal emergence section, which extends contiguously around the circumference on a radially outer circumferential side of the at least one signal wave guide body with respect to the imaginary axis and in which electromagnetic scanning signals, which are guided in the at least one signal wave guide body, can emerge from the at least one signal wave guide body.

According to the invention, the at least one signal dispersion unit has at least one signal wave guide body. The signal wave guide body has at least one signal emergence section on a radially outer circumferential side. The at least one signal emergence section extends contiguously around the circumference with respect to the imaginary axis. The at least one signal emergence section extends over an angle of 360° around the imaginary axis. In the signal wave guide body, the electromagnetic scanning signals can be guided at different points of the at least one signal emergence section. In the at least one signal emergence section, scanning signals guided in the signal wave guide body can emerge from the signal wave guide body and can be emitted into the monitoring region, or an illumination field of the emitting unit. An annular monitoring region or an annular illumination field can thus be illuminated using scanning signals.

The signal emergence section can have at least one signal emergence surface, through which the scanning signals can pass out of the signal wave guide body into the surroundings. In this way, the monitoring region can be illuminated over an angle of 360° around the imaginary axis using scanning signals.

The emitting unit according to the invention comprising at least one signal source and at least one signal wave guide body can be implemented more easily than the arrangement of a light source comprising a mirror optical unit or a catadioptric optical unit, which is known from the prior art. In particular, the emitting unit according to the invention can be implemented using a lower component expenditure than the device known from the prior art. Furthermore, the emitting unit according to the invention can be adjusted more easily.

Advantageously, at least one monitoring region can be the overlap of at least one illumination field of the at least one emitting unit and a receiving field of view of the at least one receiving unit. An illumination field of the at least one emitting unit is a spatial region which can be illuminated by the at least one emitting unit using electromagnetic scanning signals. A receiving field of view of the at least one receiving unit is a spatial region from which echo signals can be received using the at least one receiving unit. Using the at least one emitting unit, electromagnetic scanning signals are emitted at least into the at least one monitoring region. In addition, the detection device can also be designed so that electromagnetic scanning signals also illuminate regions outside the at least one monitoring region, thus outside the receiving field of view of the at least one receiving unit. In this way, an overlap of the receiving field of view and the illumination field and thus a monitoring region can be enlarged.

The at least one signal wave guide body can advantageously be a wave guide for electromagnetic scanning signals, in particular an optical fiber. In this way, the waves of the electromagnetic scanning signals can be guided.

A signal coupling region is the region of a signal wave guide body in which scanning signals generated by at least one signal source are coupled into the signal wave guide body. A signal entry surface is a surface of a signal wave guide body which delimits the signal wave guide body in the signal coupling region toward the surroundings, in particular toward the entry side. The scanning signals coming from a signal source pass through the signal entry surface into the signal wave guide body.

The electromagnetic scanning signals and accordingly the electromagnetic echo signals can advantageously be light signals in a wavelength range visible or not visible to the human eye. In this way, components suitable for light signals can be used.

Dispersion of scanning signals in the meaning of the invention means that portions of the scanning signals are dispersed away from one another. The directions of the portions dispersed away from one another differ in this case. Upon the dispersion, a signal beam of a scanning signal is so to speak expanded.

Advantageously, the detection device can operate according to a signal time-of-flight method, in particular a signal pulse time-of-flight method. Detection devices operating according to the signal pulse time-of-flight method can be configured and referred to as a time-of-flight (TOF) system, indirect time-of-flight (iTOF) system, light detection and ranging (LiDAR) system, laser detection and ranging (LaDAR) system or the like. Using a signal time-of-flight method, distances of objects detected using the detection device can be determined from scanning signals and corresponding echo signals.

The detection device can advantageously be embodied as a so-called flash system, in particular as flash LiDAR. In this case, scanning signals, in particular portions of scanning signals, can simultaneously illuminate a larger area of the monitoring region or the entire monitoring region.

Advantageously, the detection device can be embodied as a laser-based distance measurement system. Laser-based distance measurement systems can have lasers, in particular diode lasers, as signal sources. In particular, pulsed laser beams can be emitted as a scanning signal using lasers. Lasers can be used to emit scanning signals in wavelength ranges that are visible or not visible to the human eye. Accordingly, receivers of at least one receiving unit of the detection device can comprise or consist of detectors designed for the wavelength of the emitted scanning signals, in particular point sensors, line sensors, and/or surface sensors, in particular (avalanche) photodiodes, photodiode lines, CCD sensors, active pixel sensors, in particular CMOS sensors, or the like.

Advantageously, at least one emitting unit can have at least one surface emitter as a signal source. A surface emitter, also designated as a vertical-cavity surface-emitting laser (VCSEL), is a semiconductor laser in which the electromagnetic scanning signals are emitted perpendicular to the plane of the semiconductor chip. In this way, the scanning signals can deliberately be emitted toward the at least one signal wave guide body.

The invention can advantageously be used in vehicles, in particular motor vehicles. The invention can advantageously be used in land vehicles, in particular passenger vehicles, trucks, buses, motorcycles or the like, aircraft, in particular drones, and/or watercraft. The invention can also be used in vehicles that can be operated autonomously or at least semi-autonomously. However, the invention is not restricted to vehicles. It can also be used in stationary operation, in robotics and/or in machines, in particular construction or transport machinery, such as cranes, excavators or the like.

The detection device can advantageously be connected to or can be part of at least one electronic control device of a vehicle or of a machine, in particular a driver assistance system and/or a chassis control system and/or a driver information device and/or a parking assistance system and/or a gesture recognition system or the like. In this way, at least some of the functions of the vehicle or of the machine can be performed autonomously or semi-autonomously.

The detection device can be used for detecting stationary or moving objects, in particular vehicles, persons, animals, plants, obstacles, roadway irregularities, in particular potholes or rocks, roadway boundaries, traffic signs, open spaces, in particular parking spaces, precipitation or the like, and/or movements and/or gestures.

In one advantageous embodiment, at least one signal coupling region can be arranged within the at least one circumferential signal emergence section. In this way, the at least one signal source can be arranged so that it does not cover the illumination field outside the at least one signal emergence section.

In a further advantageous embodiment, at least one dispersion means for dispersing electromagnetic scanning signals can be implemented at least partially in at least one signal coupling region of the at least one signal wave guide body and/or at least one dispersion means for dispersing electromagnetic scanning signals can be implemented at least partially using at least one signal entry surface in at least one signal coupling region of the at least one signal wave guide body, which has different directions at least in some sections, and/or at least one dispersion means for dispersing electromagnetic scanning signals can be implemented at least partially using multiple signal entry surfaces in at least one signal coupling region of the at least one signal wave guide body, which have different directions, and/or at least one dispersion means for dispersing electromagnetic scanning signals can be implemented at least partially using at least one surface, which is at least partially reflective for electromagnetic scanning signals, of the at least one signal wave guide body. In this way, dispersion means, using which electromagnetic scanning signals can be dispersed, can be implemented easily and/or in a space-saving manner in conjunction with the at least one signal wave guide body. The scanning signals can be both guided and dispersed using the at least one signal wave guide body. No further means, for example optics or the like, are required for this purpose.

At least one dispersion means can advantageously be at least partially implemented in at least one signal coupling region of the at least one signal wave guide body. The scanning signals can thus already be dispersed upon entering the at least one signal wave guide body.

The at least one signal coupling region can be designed such that scanning signals coming from the at least one signal source are already dispersed upon entry into the at least one signal wave guide body. Alternatively or additionally, a separate dispersion means can be arranged between at least one signal source and at least one signal coupling region. In this way, the sampling signals can already be dispersed before entering the at least one signal wave guide body.

Alternatively or additionally, at least one dispersion means can advantageously be implemented at least partially using at least one signal entry surface in at least one signal coupling region of the at least one signal wave guide body, which has different directions at least in some sections. In this way, the scanning signals can be deflected and thus dispersed in different directions upon passage through the at least one signal entry surface and also in combination with the reflection surfaces.

Alternatively or additionally, at least one dispersion means for dispersing electromagnetic scanning signals can be at least partially implemented using multiple signal entry surfaces in at least one signal coupling region of the at least one signal wave guide body, which have different directions. The scanning signals can be dispersed more deliberately in this way.

Alternatively or additionally, at least one dispersion means can advantageously be implemented using at least one surface, which is at least partially reflective for scanning signals, of the at least one signal wave guide body. In this way, no separate dispersion means are necessary. Surfaces at least partially reflective for scanning signals can be easily implemented in particular by coating corresponding surfaces of the at least one signal wave guide body.

Advantageously, at least one signal entry surface of at least one signal wave guide body can be semi-transparent for electromagnetic scanning signals. In this way, the scanning signals can pass into the signal wave guide body through the at least one signal entry surface. In the reverse direction, scanning signals which are guided in the signal wave guide body are reflected on the at least one signal entry surface. The scanning signals thus cannot pass out of the signal wave guide body through the at least one signal entry surface.

Advantageously, at least one dispersion means can be implemented using outer surfaces, which are at least partially reflected for electromagnetic scanning signals, of the at least one signal wave guide body. Outer surfaces of the at least one signal wave guide body can easily be provided from the outside with corresponding coatings having a reflective effect, in particular metal coatings or the like.

In a further advantageous embodiment, at least one dispersion means for dispersing electromagnetic scanning signals can be at least partially implemented using at least a part of at least one signal emergence section and/or at least one dispersion means for dispersing electromagnetic scanning signals can be implemented using at least a part of at least one signal emergence surface of at least one signal emergence section, which has different directions at least in some sections, and/or at least one signal emergence surface of at least one signal emergence section can be concavely curved at least in some sections viewed from the imaginary axis and/or at least one signal emergence surface of at least one signal emergence section can implement a structure which is at least partially reflective for electromagnetic scanning signals at least in some sections. In this way, using the at least one signal emergence section, at least one dispersion means can be implemented for dispersing the scanning signals upon the emergence from the at least one signal wave guide body.

Advantageously, at least one dispersion means can be implemented using at least a part of the at least one signal emergence surface of at least one signal emergence section, which has different directions at least in some sections. In this way, a dispersion of the scanning signals upon the emergence from the at least one signal wave guide body can be implemented using the signal emergence surface.

Alternatively or additionally, at least one signal emergence surface of at least one signal emergence section can advantageously be concavely curved at least in some sections viewed from the imaginary axis. In this way, a signal emergence section can be implemented having a dispersive effect for the scanning signals.

Alternatively or additionally, at least one signal emergence surface of at least one signal emergence section can advantageously implement at least in some sections a structure which is at least partially reflective for electromagnetic scanning signals. With the aid of the at least partially reflective structure, scanning signals which come from the interior of the at least one signal wave guide body can be partially reflected on the inside of the at least one signal emergence surface and partially transmitted through the signal emergence surface. In this way, the dispersion of the scanning signals can be further improved.

The portion of the scanning signals reflected on the partially reflective structure, if the portion is incident on other regions which are at least partially reflective, can be reflected again, or if reflected portions of the scanning signals are incident on regions of the at least one signal emergence surface which are at least partially transmissive, can pass out of the signal wave guide body. Overall, the dispersion of the scanning signals can thus be further improved and the illumination field can be more uniformly illuminated using scanning signals.

Advantageously, at least one at least partially reflective structure of the at least one signal emergence surface can be a sawtooth structure.

Advantageously, the at least one signal emergence surface can have an illuminating shape, in particular a concave shape and/or a sawtooth structure, at least in some sections. In this way, the dispersion of the scanning signals can be further improved.

In a further advantageous embodiment, at least one signal emergence section, in particular at least one signal emergence surface of at least one signal emergence section, viewed in the direction of the imaginary axis, can extend at least in some sections along a circle, an ellipse, an oval, and/or a polygon, in particular a square or a rectangle, and/or at least one signal emergence surface of at least one signal emergence section can be directed at least in some sections with respect to the imaginary axis from radially inside to radially outside, in particular radially. In this way, an illumination field enclosing the at least one signal wave guide body on the radial outside with respect to the imaginary axis can be better illuminated using scanning signals.

Advantageously, at least one signal emergence section, in particular at least one signal emergence surface of at least one signal emergence section, viewed in the direction of the imaginary axis, can extend at least in some sections along a circle, an ellipse, an oval, and/or a polygon, in particular a square or a rectangle. In this way, the at least one signal wave guide body can be implemented having a defined shape more easily. Depending on the intended use of the detection device and/or the structure of the components of the detection device, the at least one signal emergence section can be shaped accordingly.

Alternatively or additionally, at least one signal emergence surface of at least one signal emergence section can advantageously be directed at least in some sections from radially inside to radially outside with respect to the imaginary axis. In this way, a circumferential illumination field with respect to the axis can be illuminated from radially inside to radially outside using scanning signals.

Advantageously, the at least one signal emergence surface can be directed at least in some sections obliquely in relation to the imaginary axis. In this way, scanning signals which are guided to the at least one signal emergence surface in a plane perpendicular to the imaginary axis can be deflected from this plane upon the passage through the at least one signal emergence surface. The extent of the illumination field in the direction of the imaginary axis can thus be enlarged.

Alternatively or additionally, the at least one signal emergence surface can be directed at least in some sections perpendicularly to the imaginary axis, thus radially. In this way, scanning signals which are guided to the at least one signal emergence surface in the plane perpendicular to the imaginary axis can remain in this plane upon passage through the at least one signal emergence surface.

In a further advantageous embodiment, the detection device can be an underbody LiDAR system, a 360° LiDAR system, or a 360° underbody LiDAR system. Positions of detected objects in the monitoring region can be determined using a LIDAR system.

A region below a vehicle can be monitored for objects using an underbody LiDAR system. Objects located under the vehicle can thus be recognized, which can be damaged if they are driven over by the vehicle and/or can damage the vehicle. In particular children or animals can thus be recognized that could be injured if they are driven over by the vehicle.

The surroundings can be monitored continuously with respect to the imaginary axis in the circumferential direction using a 360° LiDAR system.

The region below the vehicle can be continuously monitored in the circumferential direction with respect to the imaginary axis using a 360° underbody LiDAR system.

In a further advantageous embodiment, at least one signal wave guide body can have at least one plate made of medium guiding signal waves of scanning signals, the outer circumferential side of which forms a signal emergence section, and/or at least one signal wave guide body can have at least one ring made of medium guiding signal waves of scanning signals, the outer circumferential side of which forms a signal emergence section. In this way, the at least one signal wave guide body can be implemented more simply and more compactly.

Advantageously, at least one signal wave guide body can have at least one plate made of medium guiding signal waves of scanning signals. In this way, scanning signals can be guided on infinitely many different signal paths within the at least one signal wave guide body. The scanning signals can thus be emitted even more uniformly into the illumination field and thus into the monitoring region.

Alternatively or additionally, at least one signal wave guide body can have at least one ring made of medium guiding signal waves of scanning signals. In this way, the scanning signals can be distributed in the signal emergence section around an opening which is surrounded by the annular signal wave guide body and radiated into the monitoring region.

Alternatively or additionally, signal paths of the at least one receiving unit can lead through the opening which is surrounded by the annular at least one signal wave guide body. The detection device can thus be constructed more compactly overall.

Advantageously, at least one signal wave guide body can have at least one annular plate. In this way, the advantages of a plate and a ring can be combined.

In a further advantageous embodiment, at least one end face axial with respect to the imaginary axis, in particular two end faces axially opposite with respect to the imaginary axis, of the at least one signal wave guide body can have reflective properties for the scanning signals. In this way, scanning signals which are guided in the at least one signal wave guide body to the at least one end face can be reflected thereon. The scanning signals thus cannot leave the at least one signal wave guide body at the axial end face. Multiple reflections within the at least one signal wave guide body are enabled by the reflection, which further improve the dispersion of the scanning signals.

Advantageously, at least one axial end face of the at least one signal wave guide body can be provided with a layer reflective for the scanning signals, in particular a metal layer or the like. In this way, the at least one end face can be provided with reflective properties easily.

In a further advantageous embodiment, the at least one signal wave guide body can implement at least one opening, through which at least one receiving signal path of at least one receiving unit leads. In this way, at least one receiver of the receiving unit and the at least one signal source can be arranged in a space-saving manner on the same side of the at least one signal wave guide body. The at least one receiver and the at least one signal source can thus be fastened on the same side of a carrier, in particular a circuit board.

In a further advantageous embodiment, an inside, which surrounds the at least one opening, of the at least one signal wave guide body can have reflective properties for scanning signals which are guided in the signal wave guide body, in particular a reflection surface. In this way, scanning signals which propagate in the at least one signal wave guide body in the direction of the at least one opening can be reflected on the inside, in particular the reflection surface. It is thus possible to prevent scanning signals from passing out of the at least one signal wave guide body into the at least one opening, in particular into the at least one receiving signal path.

Advantageously, the inside, which surrounds the at least one opening, of the at least one signal wave guide body can have a reflection surface which is in particular circumferentially contiguous with respect to the imaginary axis. Scanning signals can be reflected on the reflection surface within the at least one signal wave guide body. A reflection surface can be implemented easily in particular by coating using reflective material, in particular metal or the like.

In a further advantageous embodiment, at least one opening can taper toward its side facing toward at least one signal coupling region of the at least one signal wave guide body and/or at least one opening can have an oval shape viewed in the direction of the imaginary axis. In this way, scanning signals coming from the at least one signal coupling region and guided in the at least one signal wave guide body can be reflected at an obtuse angle on the inside, which surrounds the at least one opening, of the at least one signal wave guide body. The scanning signals can thus be guided more efficiently in the region of the at least one signal wave guide body, which is located on the side of the at least one opening facing away from the at least one signal coupling region. The scanning signals can thus be guided around the at least one opening better with the aid of reflections, in particular multiple reflections, in the at least one signal wave guide body. Blind zones behind the at least one opening viewed from the at least one signal coupling region can thus be reduced.

In a further advantageous embodiment, at least one outer reflection region, in particular an at least partially reflective embedding and/or a notch, can be arranged radially outside the at least one opening, which forms at least one outer reflection surface that faces toward the at least one opening, in particular the reflection surface around the at least one opening. In this way, scanning signals which come from the at least one opening, in particular from the reflection surface around the at least one opening, and/or from the signal coupling region and are incident on the at least one outer reflection region, can be deflected. The scanning signals can thus be so to speak guided around the opening.

Advantageously, at least one outer reflection region can be implemented using an at least partially reflective embedding, in particular metal or the like, in the material of the at least one signal wave guide body.

Alternatively or additionally, at least one outer reflection region can be implemented using a notch. The surface of the notch can be coated using an at least partially reflective material, in particular metal, and thus form the at least one outer reflection surface.

In a further advantageous embodiment, the at least one receiving unit can have at least one receiver for converting electromagnetic echo signals into electrical receiving signals and at least one receiving signal deflection unit for deflecting echo signals onto at least one receiver.

With the aid of the receiving signal deflection unit, echo signals coming from the monitoring region or the receiving field of view can be guided onto the at least one receiver.

The electromagnetic echo signals can be converted into electrical receiving signals using the at least one receiver. Electrical receiving signals can be processed using an electrical unit, in particular a control and/or evaluation unit of the detection device. Items of object information, in particular distances, directions, and/or velocities of detected objects relative to a reference region of the detection device and/or possibly the vehicle can be determined from the electrical receiving signals.

In a further advantageous embodiment, at least one receiver and at least one receiving signal deflection unit can be arranged on the same side of at least one signal wave guide body of the at least one emitting unit and/or at least one receiver and at least one receiving signal deflection unit can be arranged on opposite sides of at least one signal wave guide body, wherein the receiving signal path between the at least one receiver and the at least one receiving signal deflection unit can lead through an opening which can be implemented inside the at least one signal wave guide body. In this way, the detection device can be implemented in a simpler and/or more space-saving manner.

Advantageously, at least one receiver and at least one receiving signal deflection unit can be arranged on the same side of at least one signal wave guide body. In this way, no opening for the receiving signal path is required within the at least one signal wave guide body.

Alternatively or additionally, at least one receiver and at least one receiving signal deflection unit can be arranged on opposite sides of at least one signal wave guide body. In this way, the at least one emitting unit and the at least one receiving unit can be implemented more compactly.

In a further advantageous embodiment, at least one emitting unit and at least one receiving unit can be arranged on the same side of a carrier, in particular a circuit board, of the detection device and/or at least one emitting unit and at least one receiving unit can be arranged on opposite sides of a carrier, in particular a circuit board, of the detection device. In this way, the detection device can be designed to be more flexible overall.

Advantageously, at least one emitting unit and at least one receiving unit can be arranged on the same side of a carrier. In this way, a spatial extent in particular in the direction of the imaginary axis of the detection device can be reduced.

Alternatively or additionally, at least one emitting unit and at least one receiving unit can be implemented on opposite sides of a carrier. In this way, an opening for at least one receiving signal path inside at least one signal wave guide body can be omitted. The receiving signal path and the emitting signal path can thus be separated from one another more easily.

The carrier can advantageously be a circuit board. In addition to a holding function, electrical contacts can also be implemented with the aid of the circuit board. Signal sources of the at least one emitting unit, in particular diode lasers, receivers of the at least one receiving unit, a control and/or evaluation unit, and other electrical, electromechanical, or electro-optical components, such as electrical connecting parts, can thus be arranged and contacted directly on conductor tracks of the carrier.

In a further advantageous embodiment, the detection device can have at least one control unit, using which the emitting unit and/or the receiving unit can be controlled, and/or the detection device can have at least one evaluation unit, using which information about the at least one monitoring region can be determined on the basis of received echo signals, in particular from electrical receiving signals. In this way, control and/or evaluation functions can be implemented directly using the detection device.

The detection device can advantageously have at least one control unit. Alternatively or additionally, the detection device can have at least one evaluation unit. The control device can advantageously have a control and evaluation unit. Control functions and evaluation functions can be combined in this way.

Furthermore, the object is achieved according to the invention for the vehicle in that the at least one signal dispersion unit comprises at least one signal wave guide body for guiding electromagnetic scanning signals, wherein the at least one signal wave guide body has at least one signal coupling region for scanning signals coming from at least one signal source and at least one signal emergence section, which extends circumferentially contiguously on a radially outer circumferential side of the at least one signal wave guide body with respect to the imaginary axis and in which electromagnetic scanning signals, which are guided in the at least one signal wave guide body, can emerge from the at least one signal wave guide body.

According to the invention, the vehicle has at least one detection device which can be used to monitor at least one monitoring region. The at least one detection device can be used to monitor at least one monitoring region outside the vehicle and/or inside the vehicle, in particular for objects.

The vehicle can advantageously have at least one driver assistance system. The vehicle can be operated autonomously or semi-autonomously with the aid of a driver assistance system.

Advantageously, at least one detection apparatus can be functionally connected to at least one driver assistance system. In this way, information about a monitoring region, in particular object information determined using the at least one detection device, can be used with the at least one driver assistance system for controlling autonomous or semiautonomous operation of the vehicle.

In addition, the object is achieved according to the invention for the method in that the electromagnetic scanning signals are coupled into at least one signal wave guide body, are guided in the at least one signal wave guide body in at least one signal emergence section, which extends contiguously around the circumference of the body, and are emitted in a dispersed manner into the monitoring region from the at least one signal emergence section.

Moreover, the features and advantages indicated in connection with the detection device according to the invention, the vehicle according to the invention, and the method according to the invention and the respective advantageous embodiments thereof apply in a mutually corresponding manner and vice versa. The individual features and advantages can of course be combined with one another, wherein further advantageous effects that go beyond the sum of the individual effects may result.

### BRIEF DESCRIPTION OF THE DRAWINGS

Further advantages, features and details of the invention will become apparent from the following description, in which exemplary embodiments of the invention are explained in more detail with reference to the drawing. A person skilled in the art will expediently also consider individually the features that have been disclosed in combination in the drawing, the description and the claims and will combine them to form meaningful further combinations, in which schematically

FIG. 1 shows a passenger vehicle in the front view having a driver assistance system and a 360° underbody LiDAR system for all-around monitoring of a monitoring region under the passenger vehicle;

FIG. 2 shows a side view of a LiDAR system according to a first exemplary embodiment, which is used in the passenger vehicle from FIG. 1;

FIG. 3 shows a bottom view of a signal wave guide body of the LiDAR system from FIG. 2;

FIG. 4 shows a bottom view of a signal wave guide body, which can be used in a LiDAR system according to a second exemplary embodiment, which is similar to the LiDAR system from FIG. 2;

FIG. 5 shows a side view of a LiDAR system according to a third exemplary embodiment, which can be used in the passenger vehicle from FIG. 1;

FIG. 6 shows a bottom view of a signal wave guide body of the LiDAR system from FIG. 5;

FIG. 7 shows a bottom view of a signal wave guide body, which can be used in a LiDAR system according to a fourth exemplary embodiment, which is similar to the LiDAR system from FIG. 5;

FIG. 8 shows a bottom view of a signal wave guide body, which can be used in the LIDAR system according to a fifth exemplary embodiment, which is similar to the LiDAR system from FIG. 5;

FIG. 9 shows a bottom view of a signal wave guide body, which can be used in the LiDAR system according to a sixth exemplary embodiment, which is similar to the LiDAR system from FIG. 5.

In the figures, identical elements are provided with identical reference signs.

### EMBODIMENT(S) OF THE INVENTION

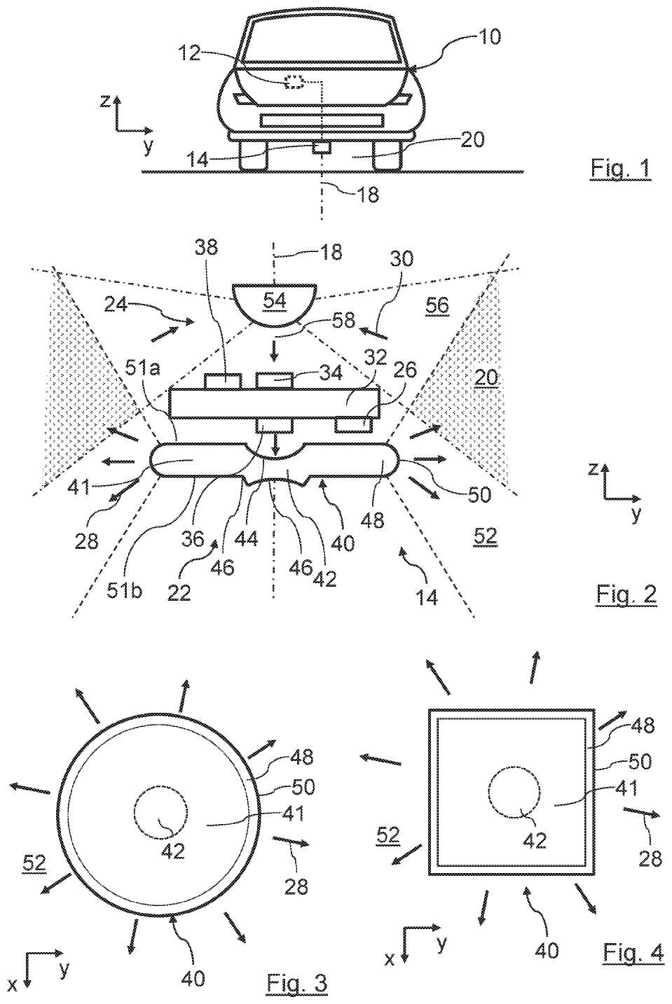

FIG. 1 shows the front view of a vehicle 10 in the form of a passenger vehicle. The vehicle 10 comprises a driver assistance system 12, using which the vehicle 10 can be operated autonomously or at least semi-autonomously. Furthermore, the vehicle 10 comprises a detection device in the form of a 360° underbody LiDAR system 14. The LiDAR system 14 is arranged, for example, centrally on the underbody of the vehicle 10.

A monitoring region 20 below the vehicle 10 can be monitored for objects using the LiDAR system 14. The monitoring region 20 extends over an angle of 360° around an imaginary axis 18. The axis 18 extends, for example, parallel to a vehicle vertical axis of the vehicle 10.

For better orientation, the corresponding coordinate axes of a Cartesian x-y-z coordinate system are shown in FIGS. 1 to 7. In the exemplary embodiments shown, the x axis extends in the direction of travel parallel to a vehicle longitudinal axis of the motor vehicle 10, the y axis extends parallel to a vehicle transverse axis, and the z axis extends perpendicular to the x-y plane parallel to a vehicle vertical axis spatially upward. When the motor vehicle 10 is in operation on a horizontal roadway, the x axis and the y axis extend spatially horizontally and the z axis extends spatially vertically.

The LiDAR system 14 can be used to detect stationary or moving objects, for example people, animals, or other objects located below the vehicle 10.

The LiDAR system 14 is functionally connected to the driver assistance system 12. Items of information from the monitoring region 20 which are detected using the LiDAR system 14 can be transmitted to the driver assistance system 12. The driver assistance system 12 can operate the vehicle 10 or functions of the vehicle 10 autonomously or semi-autonomously on the basis of the transmitted items of information. For example, if an object is detected below the vehicle 10 using the LiDAR system 14, the driver assistance system 12 can be used to prevent the vehicle 10 from driving over it. It is thus possible to prevent an object located below the vehicle 10 from being damaged by being driven over or causing damage on the vehicle 10.

The LiDAR system 14 according to a first exemplary embodiment will be explained in more detail hereinafter on the basis of FIGS. 2 and 3. FIG. 2 shows a schematic structure of the LiDAR system 14 in a side view.

The LiDAR system 14 comprises an emitting unit 22, a receiving unit 24, and a control and evaluation unit 26.

Electromagnetic scanning signals 28, for example, in the form of laser pulses, can be emitted into an illumination field 52 using the emitting unit 22. For example, the LiDAR system 14 is designed as a so-called flash LiDAR system. The generated scanning signals 28 are emitted here simultaneously, similarly to a flash, as uniformly as possible into the illumination field 52.

Electromagnetic echo signals 30, which originate from scanning signals 28 reflected in a receiving field of view 56 of the receiving unit 24, can be received using the receiving unit 24 and converted into corresponding electrical receiving signals.

The overlap of the receiving field of view 56 with the illumination field 52 forms the monitoring region 20, which can be monitored using the LiDAR system 14.

The control and evaluation unit 26 can be used to actuate the emitting unit 22 to emit scanning signals 28. In addition, items of object information, for example distances, directions, and/or velocities of detected objects relative to the LiDAR system 14 and/or relative to the vehicle 10 can be determined using the control and evaluation unit 26 from electrical receiving signals, which are obtained using the receiving unit 24 from the echo signals 30.

Furthermore, the LiDAR system 14 comprises a circuit board 32, on which the control and evaluation unit 26, a receiver 34 of the receiving unit 24, and a signal source 36 of the emitting unit 22 are arranged. Furthermore, a connection plug 38 for connection and supply lines is arranged on the circuit board 32. The connection and supply lines lead, for example, to a control unit of the vehicle 10 and/or to the driver assistance system 12. In one embodiment (not shown), the LiDAR system 14 can comprise multiple circuit boards.

The emitting unit 22 and the receiving unit 24 are located on opposite sides of the circuit board 32.

The emitting unit 22, the receiving unit 24, the control and evaluation unit 26, and the circuit board 32 are arranged in a housing (otherwise not shown) of the LiDAR system 14, which is not shown in FIGS. 2 and 3 for better clarity. The housing of the LiDAR system 14 comprises suitable windows, which are transparent for scanning signals 28 and echo signals 30.

The emitting unit 22 comprises the above-mentioned signal source 36 and a signal dispersion unit 40.

The signal source 36 is, for example, a laser diode, for example a surface emitter (VCSEL), which is arranged on one side of the circuit board 32. The signal source 36 is designed and oriented so that the scanning signals 28 are emitted in the direction of the imaginary axis 18 away from the circuit board 32.

The signal dispersion unit 40 has a signal wave guide body 41 in the form of a plate made of a medium conductive for the electromagnetic scanning signals 28, for example a light-guiding medium, for example, plastic or glass.

The signal wave guide body 41 has a circular shape viewed in the direction of the axis 18. In FIG. 3, the signal wave guide body 41 is shown in a view of the end face 51b facing away from the circuit board 32.

The signal dispersion unit 40 has a signal coupling region 42 having a signal entry surface 44 and multiple signal reflection surfaces 46. The signal entry surface 44 and the signal reflection surfaces 46 are surfaces of the signal wave guide body 41. The signal source 36 and the signal coupling region 42 are arranged along the axis 18. The scanning signals 28 coming from the signal source 36 can be coupled into the signal wave guide body 41 in the signal coupling region 42.

The signal entry surface 44 is located on the end face 51a of the signal wave guide body 41 facing toward the signal source 36. The signal entry surface 44 is transparent for scanning signals 28 only coming in the direction from the signal source 36. Scanning signals 28 can thus pass into the signal wave guide body 41 but not out of it. On the inside facing toward the signal wave guide body 41, the signal entry surface 44 has a reflective effect on the scanning signals 28. The signal entry surface 44 is concavely curved viewed from the signal source 36. The scanning signals 28 are thus dispersed away from the axis 18 upon entry into the signal wave guide body 41.

The signal reflection surfaces 46 are located on the end face 51b of the signal wave guide body 41 opposite to the signal entry surface 44. The signal reflection surfaces 46 are reflective for scanning signals 28 on their sides facing toward the interior of the signal wave guide body 41. For this purpose, the outer sides of the signal wave guide body 41 can be at least partially coated using a reflective material, for example metal or the like. A central signal reflection surface 46 is convexly curved viewed from the signal source 36, for example. A lateral signal reflection surface 46 extends obliquely to the central signal reflection surface 46. In this way, scanning signals 28 reflected on the signal reflection surfaces 46 are dispersed away from the axis 18.

The portions of the scanning signals 28 dispersed on the signal entry surface 44 and the portions of the scanning signals 28 reflected and dispersed on the signal reflection surfaces 46 are guided in different directions inside the signal wave guide body 41. The signal coupling region 42 having the signal entry surface 44 and the signal reflection surfaces 46 forms entry-side dispersion means for dispersing the scanning signals 28.

The signal wave guide body 41 has a substantially circumferentially contiguous signal emergence section 48 radially outside with respect to the axis 18. The radially outer circumferential sides of the signal emergence section 48 form a circumferentially continuous signal emergence surface 50 for the scanning signals. The signal emergence surface 50 is transparent for the scanning signals 28. The signal emergence section 48 is rounded in the region of the signal emergence surface 50. Viewed from the axis 18, the signal emergence surface 50 is concavely curved. Overall, the signal emergence section 48 has a dispersive effect on the emerging scanning signals 28 both in the direction of the axis 18 and also in the tangential direction with respect to the axis 18. The signal emergence section 48 thus forms emergence-side dispersion means for the scanning signals 28.

The axial projections of the signal coupling region 42 and the signal source 36 with respect to the axis 18 are located inside the signal emergence section 48. In this way, the propagation of the scanning signals 28 outside the signal emergence section 48 is not impaired by the signal source 36 and the signal coupling region 42.

The end faces 51a and 51b of the signal wave guide body 41 are each made reflective for the scanning signals 28. For example, the end faces 51a and 51b can be reflectively coated, for example using metal. The scanning signals 28 which are guided in the signal wave guide body 41 and are incident on the reflective end faces 51a and 51b of the signal wave guide body 41, are reflected thereon.

The scanning signals 28 are dispersed upon entering the signal wave guide body 41 in the signal coupling region 42. The dispersed portions of the scanning signals 28 are, for example, dispersed uniformly in the signal emergence section 48 using the signal wave guide body 41. Preferred directions of the illumination can also be specified here, however. The portions of the scanning signals 28 are further dispersed upon passage through the signal emergence surface 50 using the signal emergence section 48. Overall, an illumination field 52 is illuminated using the emitting unit 22, which extends circumferentially contiguously in an angle of 360° around the axis 18 and expands radially outward in the direction of the axis 18.

The receiving unit 24 comprises a receiving signal deflection unit 54 and the receiver 34. The receiver 34 and the receiving signal deflection unit 54 are arranged, for example, along the axis 18.

The receiving signal deflection unit 54 comprises, for example, a panoramic mirror. An alternative embodiment can additionally or alternatively have a corresponding optical lens. Echo signals 30 coming from the monitoring region 22 can be guided onto the receiver 34 using the receiving signal deflection unit 54. Using the receiving signal deflection unit 54, a receiving field of view 56 can be implemented which extends over an angle of 360° around the axis 18 and which expands radially outward in the direction of the axis 18.

The receiver 34 is, for example, a surface sensor, for example a CCD sensor or an active pixel sensor, for example a CMOS sensor. Alternatively, the receiver 34 can have or consist of at least one point sensor or line sensor, for example, at least one (avalanche) photodiode or at least one photodiode line. Electromagnetic echo signals 30 are converted into electrical scanning signals using the receiver 34.

The receiver 34 and the receiving signal deflection unit 54 are located on the same side of the circuit board 32 and the same side of the signal wave guide body 41.

FIG. 4 shows a signal wave guide body 41 for a LiDAR system according to a second exemplary embodiment in a view of the end face 51a facing toward the circuit board 32. The elements that are similar to those of the first exemplary embodiment from FIGS. 2 and 3 are provided with the same reference signs. In contrast to the first exemplary embodiment, the signal wave guide body 41 for the LiDAR system according to the second exemplary embodiment is a square plate. Except for the shape of the signal wave guide body 41, the LiDAR system according to the second exemplary embodiment is identical to the LiDAR system 14 according to the first exemplary embodiment.

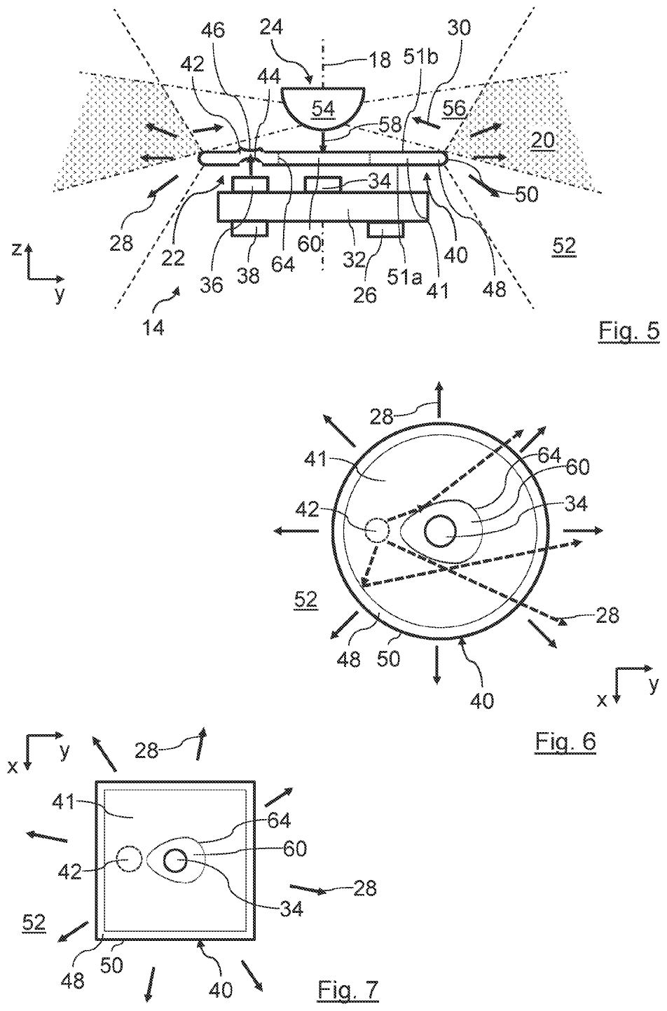

FIGS. 5 and 6 show a LiDAR system 14 according to a third exemplary embodiment. The elements that are similar to those of the first exemplary embodiment from FIGS. 2 and 3 are provided with the same reference signs. In contrast to the first exemplary embodiment from FIGS. 2 and 3, in the third exemplary embodiment, the emitting unit 22 and the receiving unit 24 are arranged on the same side of the circuit board 32. The receiver 34 and the signal source 36 are fastened here on the same side of the circuit board 32.

FIG. 5 shows the LiDAR system 14 in a side view. In FIG. 6, the signal wave guide body 41 of the LiDAR system 14 is shown in the top view observed from the receiving signal deflection unit 54.

The circuit board 32 having the receiver 34 and the signal source 36 are arranged on the same side of the signal wave guide body 41.

The receiving signal deflection unit 54 and the receiver 34 are arranged on opposite sides of the signal wave guide body 41. A receiving signal path 58 between the receiving signal deflection unit 54 and the receiver 34 leads through a continuous opening 60 of the signal wave guide body. The axis 18 leads through the opening 60.

The signal coupling region 42 is located eccentrically to the axis 18 outside the opening 60.

The opening 60 approximately has an oval shape viewed in the direction of the axis 18. The oval opening 60 tapers toward its side facing toward the signal coupling region 42.

The signal wave guide body 41 having the opening 60 overall has the shape of an annular plate.

The radially inner circumferential side of the signal wave guide body 41, which surrounds the opening 60, forms a reflection surface 64 for the scanning signals 28 guided in the signal wave guide body 41. For example, the radially inner circumferential side of the signal wave guide body 41 can be coated using reflective material, for example metal or the like. In this way, scanning signals 28 cannot pass out of the signal wave guide body 41 into the opening 60 and the receiving signal path 58 therein.

The signal emergence surface 50 has an illuminating shape, for example, a concave shape observed from the axis 18 and a sawtooth structure 62. The sawtooth structure 62 causes portions of the scanning signals 28 incident on the inside of the signal emergence surface 50 to pass partially directly outward through the signal emergence surface 50 into the illumination field 52 and to be partially reflected. In one variant (not shown) of the third exemplary embodiment, the sawtooth structure 62 is omitted.

Scanning signals 28 which are guided by the signal coupling region 42 in the direction of the opening 60 are reflected on the reflection surface 64 and at an obtuse angle.

Overall, scanning signals 28 coming from the signal coupling region 42 are deflected using the reflection surface 64 and the sawtooth structure 62 by multiple reflections within the signal wave guide body 41 so that portions of the scanning signals 28 emerge from the signal wave guide body 41 uniformly distributed around the circumference with respect to the axis 18. A part of the scanning signals 28 is so to speak guided around the opening 60 here. The invention makes it possible that the receiving signal path 58 can extend through the signal wave guide body 41 without this resulting in blind zones in the illumination field 52. Several exemplary beam paths for dispersed portions of the scanning signal 28 are indicated by dashed lines in FIG. 6.

Furthermore, time delays between the portions of the scanning signals 28 emitted into the different regions of the illumination field 52 are reduced by the special interaction of the oval reflection surface 64 and the sawtooth structure 62.

FIG. 7 shows a signal wave guide body 41 of a LiDAR system according to a fourth exemplary embodiment in a view of the end face facing toward the circuit board. The elements that are similar to those of the third exemplary embodiment from FIGS. 5 and 6 are provided with the same reference signs. In contrast to the third exemplary embodiment from FIGS. 5 and 6, the signal wave guide body 41 in the fourth exemplary embodiment is an outwardly square annular plate. Except for the shape of the signal wave guide body 41, the LiDAR system according to the fourth exemplary embodiment is identical to the LiDAR system 14 according to the third exemplary embodiment.

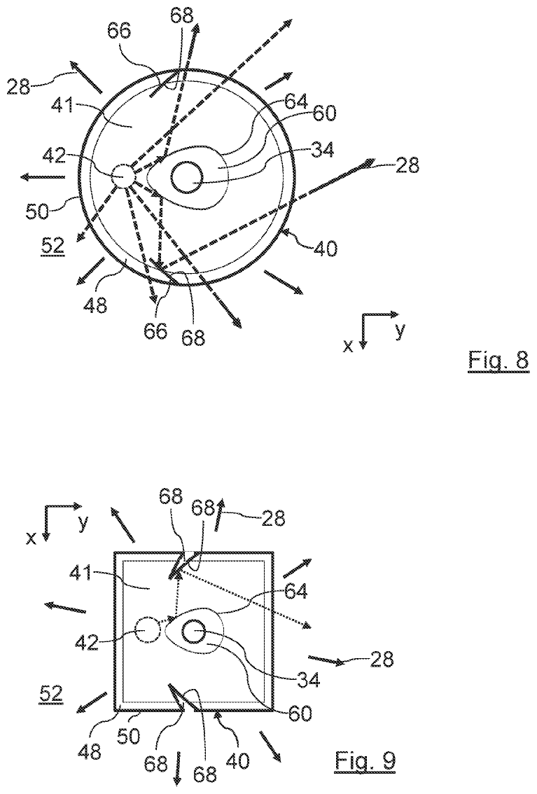

FIG. 8 shows a LiDAR system 14 according to a fifth exemplary embodiment. The elements that are similar to those of the third exemplary embodiment from FIGS. 5 and 6 are provided with the same reference signs. In contrast to the third exemplary embodiment, two outer reflection regions 66 are additionally provided in the fifth exemplary embodiment.

The outer reflection regions 66 are located, viewed from the signal coupling region 42, at the same height on opposite sides of the opening 60 within the signal emergence surface 50. For example, the outer reflection regions 66 are each located in the region of the signal emergence section 48.

The outer reflection regions 66 are implemented, for example, using material reflective for the scanning signals 68, for example metal, which is embedded in the material of the signal wave guide body 41.

The outer reflection regions 66 each have an outer reflection surface 68 reflective for the scanning signals 28, which face obliquely toward the reflection surface 64 around the opening 60. The outer reflection surfaces 68 have a concave course viewed from the opening 60. The outer reflection surfaces 68 each extend obliquely in relation to the circumference around the axis 18. The edge of the outer reflection surfaces 68 which faces toward the signal coupling region 42 is in each case here closer to the axis 18 than the edge facing away. The edge of the outer reflection surface 68 which faces away from the signal coupling region 42 in each case adjoins the signal emergence surface 50.

Scanning signals 28, which are reflected from the reflection surface 64 of the opening 60, are reflected behind the rear side of the opening 60 facing away from the signal coupling region 42 using the outer reflection surfaces 68. In this way, the scanning signals 28 are so to speak guided around the opening 60.

In one embodiment (not shown) of the fifth exemplary embodiment, the outer reflection regions 66 and the outer reflection surfaces 68 can also be only partially reflective for the scanning signals 28. In this way, a part of the scanning signals 28 can pass through the outer reflection regions 66 out of the signal wave guide body 41.

FIG. 9 shows a LiDAR system 14 according to a sixth exemplary embodiment. Those elements which are similar to those of the fifth exemplary embodiment from FIG. 8 are provided with the same reference signs. In contrast to the fifth exemplary embodiment, in the sixth exemplary embodiment the reflection regions 66 are implemented in the form of notches on the edge of the signal wave guide body 41. The notches are reflectively coated, for example, using metal. The coated surfaces of the notches form the outer reflection surfaces 68.

In addition, the signal wave guide body 41 having the hole 60 is an outwardly square annular plate analogous to the fourth exemplary embodiment from FIG. 7.

1. A detection device of a vehicle, for monitoring at least one monitoring region by means of electromagnetic scanning signals, the detection device comprising
at least one emitting unit for emitting electromagnetic scanning signals into the at least one monitoring region; and
at least one receiving unit for receiving electromagnetic echo signals, which originate from scanning signals reflected in the at least one monitoring region,
wherein the at least one emitting unit comprises at least one signal source for generating electromagnetic scanning signals and at least one signal dispersion unit for dispersing electromagnetic scanning signals generated using the at least one signal source into at least one monitoring region surrounding an imaginary axis,
wherein the at least one signal dispersion unit comprises at least one signal wave guide body for guiding electromagnetic scanning signals, and
wherein the at least one signal wave guide body comprises at least one signal coupling region for scanning signals coming from at least one signal source and at least one signal emergence section, which extends circumferentially contiguously on a radially outer circumferential side of the at least one signal wave guide body with respect to the imaginary axis and in which electromagnetic scanning signals, which are guided in the at least one signal wave guide body, are able to emerge from the at least one signal wave guide body.

2. The detection device as claimed in claim 1,
wherein at least one signal coupling region is arranged inside the at least one circumferential signal emergence section.

3. The detection device as claimed in claim 1,
wherein at least one dispersion means for dispersing electromagnetic scanning signals is implemented at least partially in at least one signal coupling region of the at least one signal wave guide body, or
wherein at least one dispersion means for dispersing electromagnetic scanning signals is implemented at least partially using at least one signal entry surface in at least one signal coupling region of the at least one signal wave guide body, which has different directions at least in some sections, or
wherein at least one dispersion means for dispersing electromagnetic scanning signals is implemented at least partially using multiple signal entry surfaces in at least one signal coupling region of the at least one signal wave guide body, which have different directions, or
wherein at least one dispersion means for dispersing electromagnetic scanning signals is implemented at least partially using at least one surface of the at least one signal wave guide body which is at least partially reflective for electromagnetic scanning signals.

4. The detection device as claimed in claim 1,
wherein at least one dispersion means for dispersing electromagnetic scanning signals is implemented at least partially using at least one part of at least one signal emergence section, or
wherein at least one dispersion means for dispersing electromagnetic scanning signals is implemented using at least one part of at least one signal emergence surface of at least one of at least one signal emergence section, which has different directions at least in some sections, or
wherein at least one signal emergence surface of at least one signal emergence section is concavely curved at least in some sections viewed from the imaginary axis or
wherein at least one signal emergence surface of at least one signal emergence section at least in some sections implements a structure at least partially reflective for electromagnetic scanning signals .

5. The detection device as claimed in claim 1,
wherein at least one signal emergence surface of at least one signal emergence section, viewed in the direction of the imaginary axis, extends at least in some sections along a flat shape, or
wherein at least one signal emergence surface of at least one signal emergence section is directed from radially inside to radially outside, at least in some sections with respect to the imaginary axis.

6. The detection device as claimed in claim 1,
wherein the detection device is an underbody LiDAR system, a 360° LiDAR system, or a 360° underbody LiDAR system.

7. The detection device as claimed in claim 1,
wherein at least one signal wave guide body comprises at least one plate or ring made of medium conducting signal waves of scanning signals, the outer circumferential side of which forms a signal emergence section.

8. The detection device as claimed in claim 1,
wherein two end faces axially opposite with respect to the imaginary axis, of the at least one signal wave guide body have reflective properties for the scanning signals.

9. The detection device as claimed in claim 1, characterized in that wherein the at least one signal wave guide body implements at least one opening, through which at least one receiving signal path of at least one receiving unit leads.

10. The detection device as claimed in claim 9,
wherein an inside of the at least one signal wave guide body surrounding the at least one opening comprises a reflection surface, for scanning signals which are guided in the signal wave guide body.

11. The detection device as claimed in claim 9,
wherein at least one opening tapers toward its side facing toward at least one signal coupling region of the at least one signal wave guide body and
wherein at least one opening has an oval shape viewed in the direction of the imaginary axis.

12. The detection device as claimed in claim 9,
wherein, radially outside the at least one opening, at least one at least partially reflective embedding or a notch, is arranged, which forms at least one outer reflection surface, which faces toward the reflection surface around the at least one opening.

13. The detection device as claimed in claim 1,
wherein the at least one receiving unit comprises at least one receiver for converting electromagnetic echo signals into electrical receiving signals and at least one receiving signal deflection unit for deflecting echo signals onto at least one receiver.

14. The detection device as claimed in claim 13,
wherein at least one receiver and at least one receiving signal deflection unit are arranged on the same side of at least one signal wave guide body of the at least one emitting unit, or
wherein at least one receiver and at least one receiving signal deflection unit are arranged on opposite sides of at least one signal wave guide body,
wherein the receiving signal path between the at least one receiver and the at least one receiving signal deflection unit leads through an opening, which is implemented inside the at least one signal wave guide body.

15. The detection device as claimed in claim 1,
wherein at least one emitting unit and at least one receiving unit are arranged on the same side or opposite sides of a circuit board, of the detection device.

16. The detection device as claimed in claim 1,
wherein the detection device comprises at least one control unit, using which the emitting unit and the receiving unit are able to be controlled, and
wherein the detection device comprises at least one evaluation unit, using which information about the at least one monitoring region is able to be determined from electrical receiving signals.

17. A vehicle comprising at least one detection device for monitoring at least one monitoring region by means of electromagnetic scanning signals,
wherein the at least one detection device comprises:
at least one emitting unit for emitting electromagnetic scanning signals into the at least one monitoring region, and
at least one receiving unit for receiving electromagnetic echo signals, which originate from scanning signals reflected in the at least one monitoring region,
wherein the at least one emitting unit comprises:
at least one signal source for generating electromagnetic scanning signals, and
at least one signal dispersion unit for dispersing electromagnetic scanning signals generated using the at least one signal source into at least one monitoring region surrounding an imaginary axis,
wherein the at least one signal dispersion unit comprises at least one signal wave guide body for guiding electromagnetic scanning signals,
wherein the at least one signal wave guide body comprises:
at least one signal coupling region for scanning signals coming from at least one signal source, and
at least one signal emergence section, which extends circumferentially contiguously on a radially outer circumferential side of the at least one signal wave guide body with respect to the imaginary axis and in which electromagnetic scanning signals, which are guided in the at least one signal wave guide body, are able to emerge from the at least one signal wave guide body.

18. A method for operating a detection device of a vehicle,
the method comprising, in at least one monitoring region: generating electromagnetic scanning signals using at least one signal source,
dispersing the electromagnetic scanning signals using at least one signal dispersion unit, and
emitting the electromagnetic scanning signals into at least one monitoring region surrounding an imaginary axis, and
receiving echo signals, which originate from scanning signals reflected in the at least one monitoring region,
the method further comprising:
coupling the electromagnetic scanning signals into at least one signal wave guide body,
guiding the electromagnetic scanning signals in the at least one signal wave guide body in at least one signal emergence section, which extends circumferentially contiguously around the body, and
emitting the electromagnetic scanning signals in a dispersed manner into the monitoring region from the at least one signal emergence section.
